(19) United States
(12) Patent Application Publication
(10) Pub. No.: US 2016/0295897 A1
(43) Pub. Date: Oct. 13, 2016

(54) NOVEL NON-ALLERGENIC SNACKS CONTAINING VEGETABLE PROTEINS

(71) Applicant: ROQUETTE FRERES, Lestrem (FR)

(72) Inventors: Jose LIS, LA GORGUE (FR); Philippe MARQUILLY, ENNETIERES EN WEPPES (FR); Sylvie LAGACHE, MARCQ EN BAROEUL (FR); Laetitia RETOURNE, MONT BERNANCHON (FR)

(21) Appl. No.: 15/035,522

(22) PCT Filed: Nov. 19, 2014
(86) PCT No.: PCT/FR2014/052963

§ 371 Date: May 10, 2016

(30) Foreign Application Priority Data
Nov. 19, 2013 (FR) 13 61360

(51) Int. Cl. A23J 1/00; A23J 1/14

(52) U.S. Cl. CPC A23L 1/3055; A23L 1/2005; A23J 1/14; A23L 1/0026; A23V 2002/00

(57) ABSTRACT

Novel food products to be consumed, preferably in the form of snacks, distinct in that they are fat-free, non-allergenic, and have a texture very similar to dried fruit, such as peanuts. In particular, the novel non-allergenic snacks are obtained by compressing specific vegetable proteins, preferably vegetable proteins and more preferably pea proteins.

### FIELD OF THE INVENTION

The present invention relates to novel food products, and more particularly to novel products intended to be consumed in the form of snacks, which have the distinction of being fat-free and non-allergenic and have a texture very similar to dried fruits, such as peanuts. More specifically, the present invention relates to novel non-allergenic snacks formulated from proteins which are essentially or even exclusively vegetable proteins, preferably leguminous-plant proteins and more preferentially pea proteins.

### TECHNOLOGICAL BACKGROUND

The tradition of the aperitif appears to go back to the Middle Ages. The first aperitifs had a medicinal function. The aim was to whet, or “open”, the appetite before sitting down to eat, as attested to by the Latin origin of the word “aperire” which means to open.

In the Middle Ages, to whet the appetite and promote digestion, a fortified wine flavored with herbs, to which appetite-stimulating properties were attributed, was consumed. 90% of French people partake of an aperitif, which is a special moment. Today, in France, French people have an aperitif at least once a week. It is then the prelude to a meal amongst friends or else to a dining aperitif in the manner of a dinner-tea party, an increasingly appreciated variant of the aperitif.

Nowadays, the aperitif denotes an improvised informal moment. The word itself no longer refers only to an alcoholic drink: it also signifies a moment of sharing. The traditional aperitif is usually supplemented with a range of items for snacking: crackers, dried fruits, peanuts, olives, etc. For some years it has become “culinary”. A true revelation of social change, the ritual constantly evolves according to new ways of life. On the other hand, the moment of the aperitif is often synonymous with snacking.

However, current trends are rather toward the consumption of products containing little or no fats. Indeed, some individuals concerned about their figure and their health want to consume products which are low in fat and in cholesterol and which have a low calorie content.

Chips and other derivatives are no longer universally popular. Chips are rich in saturated lipids, well known for their negative effect on cholesterol levels. According to a study published in the New England Journal of Medicine (N Engl J Med 2011; 365:1058-1059, Sep. 15, 2011), chips now appear to be the number one cause of obesity in the United States. The results of the study demonstrate that chips do not appear to contribute only to obesity and to heart disease epidemics, but the consumption of chips appears to increase, in addition to the risk of obesity, the risk of hypertension, of type II diabetes and of coronary disease. Children, the primary consumers of chips, appear to ingest, without knowing it, 5 liters of oil per year, but also an excess of salt and sugar contained in potato starch.

Furthermore, some dried fruits are known to be allergenic and the consumption thereof can therefore present risks since they can cause day-to-day reactions that are very bothersome, or even dangerous. Allergic reactions are serious adverse effects which occur when the immune system has an exaggerated reaction to a given allergen. The symptoms usually occur rapidly after consumption (before 2 hours). People who suffer from allergies exhibit one or more of the following symptoms: itching, skin rash, swelling of the face, the eyes, the lips, flushed face, tingling in the mouth, sore throat, trouble swallowing or speaking, sneezing, a cold, trouble breathing, wheezing, asthma attack, stomach ache, vomiting, diarrhea, agitation, anxiety or withdrawal with irritability, weakness, feeling of being unwell, dizziness, loss of consciousness, accelerated heart rate, drop in blood pressure.

Thus, individuals who suffer from food allergies to peanuts/groundnuts are looking for products which are totally free of these allergens.

Finally, vegetarians and vegans also refuse to consume any animal-derived products and consequently boycott all food products containing them.

Thus, there is an unmet need for novel calorie-free non-allergenic products which do not contain animal proteins, but essentially or even exclusively vegetable proteins, and which can be consumed at any time during the day and particularly at the time of the aperitif.

### SUMMARY OF THE INVENTION

After numerous research studies, the applicant company has, to its credit, found that such a need can be met by novel products, and more particularly novel snacks, obtained by compressing specific vegetable proteins. These products which have the distinction of being fat-free and non-allergenic, also have a texture very similar to dried fruits, such as peanuts, when they are consumed and are therefore very enjoyable.

The present invention therefore relates to a food product characterized in that it is obtained by compressing, preferably directly, a pulverulent composition comprising an essentially or even exclusively vegetable protein or protein mixture.

More particularly, said food product is characterized in that the vegetable protein(s) belong(s) to proteins derived from cereals, from oleaginous plants, from leguminous plants and from tubers, and also all the proteins derived from algae and from microalgae.

According to one preferred mode of the invention, said food product is characterized in that the vegetable protein(s) belong(s) to leguminous-plant proteins, the leguminous-plant protein preferably being chosen from the group consisting of alfalfa protein, clover protein, lupin protein, pea protein, bean protein, broad bean protein, horse bean protein, lentil protein, and mixtures thereof. The vegetable protein is preferably a pea protein.

According to a first embodiment of the invention, the food product is characterized in that it contains at least 15%, preferably at least 20%, of a composition of vegetable proteins, these percentages being expressed relative to the total weight of the ingredients used in the recipe for preparing said product.

According to another embodiment of the invention, the food product is characterized in that it contains at least 50%, preferably at least 60%, even more preferentially at least 70%, of a composition of vegetable proteins, these percentages being expressed relative to the total weight of the ingredients used in the recipe for preparing said product.

According to one preferred mode, the food product contains at least 75% of a composition of vegetable proteins, this percentage being expressed relative to the total weight of the ingredients used in the recipe for preparing said product.

According to the invention, the food product also contains from 15% to 50% of a soluble vegetable fiber, this percentage being expressed relative to the total weight of the ingredients used in the recipe for preparing said product. Preferably, the soluble vegetable fiber is chosen from fructans including fructooligosaccharides (FOSs) and inulin, glucooligosaccharides (GOSs), isomaltooligosaccharides (IMOs), trans-galactooligosaccharides (TOSs), pyrodextrins, polydextrose, branched maltodextrins, indigestible dextrins and soluble oligosaccharides derived from oleaginous or protein-producing plants or mixtures thereof.

According to one particularly advantageous embodiment, the soluble vegetable fiber is a branched maltodextrin.

Moreover, the food product contains from 15% to 50% of a microalgal flour, this percentage being expressed relative to the total weight of the ingredients used in the recipe for preparing said product. More particularly, the microalgal flour is a flour of microalgae of the Chlorella genus, and even more particularly of the Chlorella protothecoides species.

According to another embodiment, the food product contains from 1% to 15% of at least one polyol, and preferably of sorbitol.

In addition, said food product contains between 1% and 10%, and preferably between 2% and 6%, of flavorings, these percentages being expressed relative to the total weight of the ingredients used in the recipe for preparing said product.

The food product may also have undergone a final treatment chosen from hard sweet-coating and film-coating.

Finally, the present invention also relates to a process for preparing said food product, characterized in that it comprises the following steps:
of preparing a pulverulent composition comprising a vegetable protein or a vegetable protein mixture, preferably as a mixture with at least one flavoring;
of filling the matrix of a press with said mixture;
of the action of directly compressing the mixture using a punch (loading);
of withdrawing the punch which produces the compression (unloading);
of ejecting the tablet;
and optionally of subjecting said tablet to a hard sweet-coating or film-coating process.

According to one advantageous mode, the invention also relates to the use of the food product as a substitute for allergenic dried fruit.

### DETAILED DESCRIPTION OF EMBODIMENTS

Thus, the present invention relates to novel products intended to be consumed, preferably in the form of snacks, which have the distinction of being fat-free and non-allergenic and have a texture and a taste very similar to dried fruits such as peanuts.

More specifically, the present invention relates to novel products and more particularly novel snacks which are non-allergenic and calorie-free and formulated from pulverulent compositions of essentially or even exclusively vegetable proteins.

More specifically, the invention relates to a food product characterized in that it is obtained by compressing a pulverulent composition comprising a vegetable protein or a vegetable protein mixture.

It is the combination of the use of a composition of quite specific vegetable proteins and of a compressing process which makes it possible for the product obtained to have a texture similar to that of a dried fruit when it is consumed, while at the same time dispensing with the disadvantages such as the calorie content and the allergenicity.

In the present invention, the term “snacks” denotes all the products or compositions intended to be consumed at any time of the day, and supposed to provide pleasure when they are consumed. They are therefore products that consumers will rather consume at tea time and at aperitif time, and also that are consumed during breaks referred to as snacking.

In the present invention, the term “vegetable protein” denotes all the proteins derived from cereals, from oleaginous plants, from leguminous plants and from tubers, and also all the proteins derived from algae and from microalgae, used alone or as a mixture, chosen from the same family or from different families.

These vegetable proteins used as a mixture can be chosen from the same family or from different families.

The terms “algae” and “microalgae” are intended to mean, in the present application, eukaryotic organisms devoid of root, stem and leaf, but having chlorophyll and also other secondary pigments in oxygen-producing photosynthesis. They are blue, red, yellow, golden and brown or else green.

Microalgae in the strict sense are microscopic algae. They are single-cell or undifferentiated multicellular microorganisms that are photosynthetic and are separated into two polyphyletic groups: eukaryotes and prokaryotes. Living in strongly aqueous media, they can have flagellar mobility.

According to one preferential mode, the microalgae are chosen from the group consisting of Chlorella, Spirulina and Odontella.

According to one even more preferential mode, the microalgae of the present invention are from the Chlorella genus and preferably of Chlorella vulgaris, Chlorella pyrenoidosa, Chlorella regularis, Chlorella sorokiniana, and even more preferentially of Chlorella vulgaris.

In the present application, the term “cereals” is intended to mean cultivated plants of the grass family producing edible seeds, for instance wheat, oats, rye, barley, corn, sorghum and rice. The cereals are often milled in the form of flour, but are also in the form of seeds and sometimes in the form of a whole plant (fodders).

In the present application, the term “tubers” is intended to mean all the storage organs, generally underground, which ensure the survival of plants during the winter season and often the vegetative multiplication thereof. These organs are made bulbous by the accumulation of storage substances. The organs converted into tubers may be:

the root: carrot, parsnip, cassava, konjac,
the rhizome: potato, Jerusalem artichoke, Japanese artichoke, sweet potato,
the base of the stem (more specifically the hypocotyl): kohlrabi, celeriac,
the root and hypocotyl together: beet, radish.

In the present application, the term “oleaginous plants” denotes plants cultivated specifically for their seeds or their fruits rich in fats, from which oil is extracted for food, energy or industrial use, for instance rapeseed, peanut, sunflower, soya, sesame and the caster oil plant.

For the purposes of the present invention, the term “leguminous plants” is intended to mean any plants belonging to the families caesalpiniaceae, mimosaceae or papilionaceae and in particular any plants belonging to the family papilionaceae, for instance pea, bean, broad bean, horse bean, lentil, alfalfa, clover or lupin. This definition includes in particular all the plants described in any one of the tables contained in the article by R. HOOVER et al., 1991 (HOOVER R. (1991) “Composition, structure, functionality and chemical modification of legume starches: a review” Can. J. Physiol. Pharmacol., 69 pp. 79-92).

According to one preferential mode of the present invention, the vegetable protein belongs to the leguminous-plant proteins.

In addition, according to one preferential mode, the leguminous-plant protein is chosen from the group consisting of alfalfa protein, clover protein, lupin protein, pea protein, bean protein, broad bean protein, horse bean protein, lentil protein, and mixtures thereof.

More preferably, said leguminous-plant protein is chosen from the group consisting of pea protein, bean protein, broad bean protein, horse bean protein, and mixtures thereof.

Even more preferably, said leguminous-plant protein is derived from pea.

The term “pea” is herein considered in its broadest accepted sense and includes in particular:
all varieties of “smooth pea” and of “wrinkled pea”, and
all mutant varieties of “smooth pea” and of “wrinkled pea”, this being whatever the uses for which said varieties are generally intended (food for human consumption, animal feed and/or other uses).

In the present application, the term “pea” includes the varieties of pea belonging to the Pisum genus and more particularly to the sativum and aestivum species.

Said mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium of the Industrial Biochemistry and Biotechnology Group of the Biochemical Society, 1996, pp. 77-87.

Even more preferentially, said leguminous-plant protein is derived from smooth pea.

The pea is the leguminous plant with protein-rich seeds which, since the 1970s, has been the most widely developed in Europe and mainly in France, not only as a protein source for animal feed, but also for food for human consumption.

Like all leguminous-plant proteins, pea proteins consist of three main classes of proteins: globulins, albumins and “insoluble” proteins.

The value of pea proteins lies in their good emulsifying capacities, their lack of allergenicity and their low cost, which makes them an economical functional ingredient.

Furthermore, pea proteins contribute favourably to sustainable development and their carbon impact is very low. This is because pea cultivation is environmentally friendly and does not require nitrogenous fertilizers, since the pea fixes atmospheric nitrogen.

According to the present invention, the pulverulent composition comprising at least one vegetable protein is preferably a composition comprising at least one pea protein.

According to another embodiment of the invention, the pulverulent composition or composition in powder form comprising at least one vegetable protein is a mixture of a pea protein and another vegetable protein derived from cereals, from oleaginous plants, from leguminous plants and from tubers, and also all the proteins derived from algae and from microalgae.

The pulverulent composition comprising at least one vegetable protein, in particular one pea protein, used according to the invention can advantageously have a total protein content (N×6.25) of at least 60% by weight of dry product. Preferably, in the context of the present invention, use is made of a composition having a high protein content, of between 70% and 97% by weight of dry product, preferably between 76% and 95%, even more preferentially of between 78% and 88%, and in particular of between 78% and 85%. The total protein content is measured by quantitatively determining the soluble nitrogenous fraction contained in the sample according to the Kjeldahl method. The total protein content is then obtained by multiplying the nitrogen content, expressed as percentage by weight of dry product, by the factor 6.25.

In addition, said composition comprising at least one vegetable protein, in particular one pea protein, can have a soluble protein content, expressed according to a test described hereinafter for measuring protein solubility in water, of between 20% and 99%. Preferably, in the context of the present invention, use is made of a composition having a high soluble protein content, of between 45% and 90%, even more preferentially between 50% and 80%, and in particular between 55% and 75%.

In order to determine the soluble protein content, the content of proteins soluble in water of which the pH is adjusted to 7.5+/−0.1 using a solution of HCl or NaOH is measured by means of a method of dispersion of a test specimen of the sample in distilled water, centrifugation and analysis of the supernatant. 200.0 g of distilled water at 20° C.+/−2° C. are placed in a 400 ml beaker and the whole is stirred magnetically (magnetic bar and rotation at 200 rpm). Exactly 5 g of the sample to be analyzed are added. The mixture is stirred for 30 min and centrifuged for 15 min at 4000 rpm. The method for determining nitrogen is carried out on the supernatant according to the method previously described (Kjeldahl method).

These compositions comprising at least one vegetable protein, in particular one pea protein, preferably contain more than 50%, more preferentially more than 60%, even more preferentially more than 70%, even more preferentially more than 80%, and in particular more than 90% of proteins of more than 1000 Da. The determination of the molecular weight of the protein can be carried out according to the method described hereinafter. In addition, these compositions comprising at least one vegetable protein, in particular one pea protein, preferably have a molecular weight distribution profile consisting of:
from 1% to 8%, preferably from 1.5% to 4% and even more preferentially from 1.5% to 3%, of proteins of more than 100 000 Da,
from 20% to 55%, preferably from 25% to 55%, of proteins of more than 15 000 Da and of at most 100 000 Da,
from 15% to 30% of proteins of more than 5000 Da and of at most 15 000 Da,
and from 25% to 55%, preferably from 25% to 50% and even more preferentially from 25% to 45%, of proteins of at most 5000 Da.

Examples of compositions comprise at least one vegetable protein, in particular one pea protein, according to the invention, and also the details of the method for determining the molecular weights, can be found in patent WO 2007/017572.

According to the present invention, the composition comprising at least one vegetable protein, in particular one pea protein, can be chosen from the group consisting of vegetable protein concentrate and of vegetable protein isolate, preferably of pea protein concentrate and of pea protein isolate. The vegetable protein, and in particular pea protein, concentrates and isolates are defined from the viewpoint of their protein content (cf review by J. GUEGUEN from 1983 in Proceedings of European Congress on plant proteins for human food (3-4) pp 267-304):
the vegetable protein, and in particular pea protein, concentrates are described as having a total protein content of from 60% to 75% on a dry basis, and
the vegetable protein, and in particular pea protein, isolates are described as having a total protein content of from 90% to 95% on a dry basis,
   the nitrogen content being measured by the Kjeldahl method and the protein contents being obtained by multiplying the nitrogen content, expressed as percentage of dry product, by the factor 6.25.

In another embodiment of the present invention, the composition comprising at least one vegetable protein, in particular one pea protein, may also be a “vegetable protein hydrolysate”, preferably “pea protein hydrolysate”. The vegetable protein, and in particular pea protein, hydrolysates are defined as preparations obtained by enzymatic hydrolysis or chemical hydrolysis, or by both simultaneously or successively, of vegetable proteins, and in particular pea proteins. The protein hydrolysates comprise a higher proportion of peptides of various sizes and of free amino acids than the original composition. This hydrolysis can have an impact on the solubility of the proteins. The enzymatic and/or chemical hydrolysis is for example described in patent application WO 2008/001183. Preferably, the protein hydrolysis is not complete, i.e. does not result in a composition comprising only or essentially amino acids and small peptides (from 2 to 4 amino acids). The preferred hydrolysates comprise more than 50%, more preferentially more than 60%, even more preferentially more than 70%, even more preferentially more than 80%, and in particular more than 90%, of proteins and polypeptides of more than 500 Da.

The processes for preparing protein hydrolysates are well known to those skilled in the art and can, for example, comprise the following steps: dispersion of the proteins in water so as to obtain a suspension, and hydrolysis of this suspension by the chosen treatment. It will usually be an enzymatic treatment combining a mixture of various proteases, optionally followed by a heat treatment intended to inactivate the enzymes that are still active. The solution obtained can then be filtered through one or more membranes so as to separate the insoluble compounds, optionally the residual enzyme and the high-molecular-weight peptides (greater than 10 000 Daltons).

According to one optional embodiment of the invention, the compositions comprising at least one vegetable protein, in particular one pea protein, can undergo a heat treatment at high temperature and for a short time, it being possible for said treatment to be chosen from HTST (High Temperature Short Time) and UHT (Ultra High Temperature) treatments. This treatment advantageously makes it possible to reduce the bacteriological risks.

According to a first embodiment of the invention, the food product is characterized in that it contains at least 15%, preferably at least 20%, of a composition of vegetable proteins, these percentages being expressed relative to the total weight of the ingredients used in the recipe for preparing said product.

According to another embodiment of the invention, said product is characterized in that it contains at least 50% of a composition of vegetable proteins, this percentage being expressed relative to the total weight of the ingredients used in the recipe for preparing said product.

According to another embodiment of the invention, said product is characterized in that it contains at least 60% of vegetable proteins, this percentage being expressed relative to the total weight of the ingredients used in the recipe for preparing said product.

According to another embodiment of the invention, said product is characterized in that it contains at least 70% of vegetable proteins, this percentage being expressed relative to the total weight of the ingredients used in the recipe for preparing said product.

In one preferred mode of the invention, said product is characterized in that it contains at least 75% of vegetable proteins, this percentage being expressed relative to the total weight of the ingredients used in the recipe for preparing said product.

The fact that the product according to the invention contains a high percentage of proteins makes it a nutritional supplement that is very advantageous for everyone.

Because it is in a form that is very practical for taking everywhere and for consuming under any circumstances, this makes it an important accompaniment for individuals who permanently move around, such as those who lead a nomadic existence, or for those who want to control their protein intake (sportspeople for example).

Furthermore, its consumption by protein-deficient populations, such as the elderly for example, can partly compensate for this protein deficiency and allow an intake of proteins and therefore of amino acids that are not insignificant with respect to health and well-being generally.

Likewise, the combining, in certain particular embodiments, of a high percentage of proteins with other elements such as fibers and/or other protein sources also makes it possible to further increase the already not insignificant nutritional aspect of the product according to the invention.

According to the invention, the novel food product may also be flavored through the addition of at least one flavoring (i.e. one or more flavorings).

In the present invention, the term “flavoring” denotes any substances not intended to be consumed as they are, which are added to foodstuffs to give them an odor and/or a taste or to modify said odor and/or taste. They are derived from or consist of the following categories: flavoring substances, flavoring preparations, flavorings obtained by thermal treatment, smoke flavorings, flavoring precursors or other flavorings or mixtures thereof.

The flavoring substances are defined chemical substances, which includes flavoring substances obtained by chemical synthesis or isolated by chemical processes, and natural flavoring substances. The flavoring preparations are flavorings, other than defined chemical substances, which are obtained by means of appropriate physical, enzymatic or microbiological processes, from materials of vegetable, animal or microbiological origin taken as they are or after transformation thereof for human consumption. The flavoring precursors, such as carbohydrates, oligopeptides and amino acids, give foodstuffs a flavor via chemical reactions which occur during the transformation of these foodstuffs.

According to one preferential mode, the flavoring used is chosen from the flavorings of dried fruits, such as in particular hazelnut flavoring, peanut flavoring, cashew nut flavoring, pecan nut flavoring, pistachio nut flavoring, etc.

According to another preferential embodiment, the flavoring used is chosen from the flavorings which are reminiscent of the of salty flavors of the aperitif. Thus, the flavoring used is chosen from flavorings of the type such as bacon, pizza, grilled chicken, ham, sausage, salami, sausages, quiche Lorraine and any other flavor reminiscent of those of the dishes or snacks served during the aperitif. According to one embodiment, said product is characterized in that it contains between 1% and 10% of flavorings, and preferably between 2% and 6%, these percentages being expressed relative to the total weight of the ingredients used in the recipe for preparing said product.

According to one advantageous embodiment of the invention, said product is characterized in that it also contains a vegetable fiber.

In the present invention, the term “vegetable fiber” denotes the soluble and/or insoluble vegetable dietary fibers. The vegetable fibers do not comprise starch hydrolysates.

The vegetable fibers do not denote only fibrous materials in the strict sense, but also an entire series of different compounds which are contained almost exclusively in foods of vegetable origin and which have the common property of not being able to be degraded by human digestive enzymes. Almost all dietary fibers are carbohydrate polymers. For a few years, nutritionists have been interested in a new type of dietary fiber: resistant starch. It is a starch or a starch fraction which is not digested in the small intestine and which is fermented by the bacteria of the colon.

Unlike the conventional vegetable fibers, these starches have the advantage of not modifying the appearance of the product into which they are incorporated and constitute as it were a source of fibers that is invisible to the naked eye. These starches are recommended in many applications.

Thus, in the present invention, the vegetable fiber is chosen from soluble fibers, insoluble fibers or mixtures thereof.

According to a first advantageous embodiment of the invention, the vegetable fiber is an insoluble vegetable fiber, chosen from resistant starches. Natural resistant starches or resistant starches obtained by chemical and/or physical and/or enzymatic modification may be used without implied distinction.

According to the present invention, the term “resistant starch” denotes a starch or a starch fraction which is not digested in the small intestine and which is fermented by the bacteria of the colon. Four categories of resistant starch have been identified:
encapsulated starches, present in most unrefined vegetable foods such as dried vegetables, said starches being inaccessible to enzymes (RS1),
the granular starch of certain raw foods, such as banana or potato, and amylose-rich starches (RS2),
retrograded starches, which are found in foods that have been cooked and then refrigerated or frozen (RS3),
chemically modified starches such as, in particular, etherified or esterified starches (RS4).

The resistant starches proposed in particular by the company NATIONAL STARCH, such as those sold under the name HI-MAIZE®, are derived from amylose-rich corn varieties and behave like insoluble fibers. R53-type resistant starches are also proposed under the name NOVELOSE®.

These resistant starches decrease the glycaemic response, improve the health of the digestive system by virtue of their prebiotic properties and contribute to the regularity of transit, without having a high calorie content.

According to one advantageous embodiment of the present invention, said product comprises a mixture of a composition of vegetable proteins, preferably leguminous-plant proteins, and even more preferentially pea proteins, and of a soluble vegetable fiber.

According to this embodiment, the product obtained by compression comprises from 15% to 50% of a composition of vegetable proteins and from 15% to 50% of a soluble vegetable fiber.

In this advantageous embodiment of the present invention, the food product obtained by compression comprises soluble fibers and the label “rich in fibers” or “source of fibers” may be affixed to the packaging of said product. This represents an additional nutritional and marketing advantage. This will be demonstrated in the examples hereinafter.

Preferably, said soluble vegetable fiber is chosen from fructans including fructooligosaccharides (FOSs) and inulin, glucooligosaccharides (GOSs), isomaltooligosaccharides (IMOs), trans-galactooligosaccharides (TOSs), pyrodextrins, polydextrose, branched maltodextrins, indigestible dextrins and soluble oligosaccharides derived from oleaginous or protein-producing plants, or mixtures thereof

The term “soluble fiber” is intended to mean water-soluble fibers. The fibers can be quantitatively determined according to various AOAC methods. Mention may be made, by way of example, of AOAC methods 997.08 and 999.03 for fructans, FOSs and inulin, AOAC method 2000.11 for polydextrose, AOAC method 2001.03 for quantitatively determining the fibers contained in branched maltodextrins and indigestible dextrins, or AOAC method 2001.02 for GOSs and also soluble oligosaccharides derived from oleaginous or protein-producing plants. Among the soluble oligosaccharides derived from oleaginous or protein-producing plants, mention may be made of soya, rapeseed or pea oligosaccharides.

According to one advantageous embodiment of the present invention, the product comprises a mixture of a composition of vegetable proteins, preferably leguminous-plant proteins, and even more preferentially pea proteins, and of soluble vegetable fibers which are branched maltodextrins.

The term “branched maltodextrins (BMDs)” is intended to mean the specific maltodextrins identical to those described in patent EP 1 006 128-B1 of which the applicant is the proprietor. These BMDs have the advantage of representing a source of indigestible fibers beneficial to the metabolism and to intestinal equilibrium.

According to the present invention, said branched maltodextrins are characterized in that they have
between 15% and 50% of 1-6-glucosidic linkages, preferentially between 22% and 45%, more preferentially between 20% and 40%, and even more preferentially between 25% and 35%,
a reducing sugar content of less than 20%, preferentially between 2% and 20%, more preferentially between 2.5% and 15%, and even more preferentially between 3.5% and 10%,
a polydispersity index of less than 5, preferentially of between 1 and 4, more preferentially between 1.5 and 3, and
a number-average molecular weight Mn of less than 4500 g/mol, preferentially between 400 and 4500 g/mol, more preferentially between 500 and 3000 g/mol, more preferentially between 700 and 2800 g/mol, even more preferentially between 1000 and 2600 g/mol.

In particular, use may be made of BMDs having between 15% and 35% of 1-6-glucosidic linkages, a reducing sugar content of less than 20%, a weight-average molecular weight Mw of between 4000 and 6000 g/mol and a number-average molecular weight Mn of between 250 and 4500 g/mol.

Certain BMD subfamilies described in the abovementioned application can also be used in accordance with the invention. These are, for example, high-molecular-weight BMDs having a reducing sugar content at most equal to 5 and an Mn of between 2000 and 4500 g/mol. Low-molecular-weight BMDs having a reducing sugar content between 5% and 20% and a molecular weight Mn of less than 2000 g/mol can also be used.

In another advantageous embodiment of the present invention, use may also be made, in accordance with the invention, of the hypoglycemic hyperbranched maltodextrins described in application FR 1251810 of which the applicant is the proprietor.

In the present application, the pyrodextrins denote the products obtained by heating starch brought to a low moisture content, in the presence of acid or basic catalysts, and generally having a molecular weight of between 1000 and 6000 Daltons. This dry roasting of the starch, usually in the presence of acid, brings about both a depolymerization of the starch and a rearrangement of the starch fragments obtained, resulting in the obtaining of highly branched molecules. This definition targets in particular the “indigestible” dextrins, having an average molecular weight of about 2000 Daltons.

The polydextrose is a soluble fiber produced by thermal polymerization of dextrose, in the presence of sorbitol and of acid as catalyst. An example of such a product is, for example, LITESSE® sold by DANISCO.

According to one particularly advantageous mode of the present invention, the product obtained by compression according to the invention comprises NUTRIOSE®, which is a complete range of soluble fibers, recognized for their benefits, and manufactured and sold by the applicant. The products of the NUTRIOSE® range are partially hydrolyzed wheat or corn starch derivatives which contain up to 85% of fiber. This richness in fiber makes it possible to increase digestive tolerance, to improve calorie control, to prolong energy release and to obtain a lower sugar content. Furthermore, the NUTRIOSE® range is one of the best tolerated fibers available on the market. It shows a higher digestive tolerance, enabling better incorporation than other fibers, which represents real dietary advantages.

According to another advantageous embodiment of the invention, said product is characterized in that it also contains a microalgal flour.

Algae are among the first organisms which appeared on Earth, and are defined as eukaryotic organisms devoid of roots, stem and leaf, but having chlorophyll and also other secondary pigments in oxygen-producing photosynthesis. They are blue, red, yellow, golden and brown or else green. They represent more than 90% of marine plants and 18% of the plant kingdom, with their 40 000 to 45 000 species. Algae are organisms that are extremely varied both in terms of their size and their shape and in terms of their cell structure. They live in an aquatic or very humid medium. They contain numerous vitamins and trace elements, and are true concentrates of active agents that stimulate and are beneficial to health and beauty. They have anti-inflammatory, moisturizing, softening, regenerating, firming and anti-aging properties. They also have “technological” characteristics which make it possible to give a food product texture. Indeed, the famous additives E400 to E407 are in fact only compounds extracted from algae, the thickening, gelling, emulsifying and stabilizing properties of which are used.

Among the algae, macroalgae and microalgae can be distinguished, in particular single-celled microscopic algae, which are photosynthetic or non-photosynthetic, and of marine or non-marine origin, cultured in particular for their applications in biofuel or in the food sector. For example, spirulina (Arthrospira platensis) is cultured in open lagoons (under phototrophic conditions) for use as a food supplement or incorporated in small amounts into confectionery products or drinks (generally less than 0.5% w/w). Other lipid-rich microalgae, including certain species of Chlorella, are also very popular in Asian countries as food supplements (mention may be made of microalgae of the Crypthecodinium or Schizochytrium genus). The production and use of microalgal flours is described in applications WO 2010/120923 and WO 2010/045368.

For the purposes of the present invention, the term “microalgal flour” should be understood in its broadest interpretation and as denoting, for example, a composition comprising a plurality of particles of microalgal biomass. The microalgal biomass is derived from microalgal cells, which may be whole or broken, or a mixture of whole and broken cells. It is understood in the present document that the microalgal flour denotes a product essentially composed of microalgal biomass, i.e. at least 90%, 95% or 99%. In one preferred embodiment, the microalgal flour comprises only microalgal biomass.

The present invention thus relates to the microalgal biomass suitable for human consumption which is rich in nutrients, in particular in lipids and/or proteins.

The protein fraction of the microalgal flour which contains many amino acids essential to human and animal well-being therefore also provides advantageous and not insignificant nutritional and health benefits.

For the purposes of the invention, the microalgae under consideration are species which produce appropriate oils and/or lipids and/or proteins.

According to another embodiment of the invention, the microalgal biomass contains at least 30% by dry weight of proteins, at least 40% or at least 45% by dry weight of proteins.

According to one advantageous embodiment of the present invention, said product comprises a mixture of a composition of vegetable proteins, preferably leguminous-plant proteins, and even more preferentially pea proteins, and of a microalgal flour. According to this embodiment, the product obtained by compression comprises from 15% to 50% of a composition of vegetable proteins and from 15% to 50% of a microalgal flour.

According to another preferential mode of the invention, the microalgae belong to the Chlorella genus.

Chlorella is a freshwater microscopic green single-celled alga or microalga which appeared on Earth more than 3 billion years ago, belonging to the Chlorophyte branch. Chlorella possesses the greatest concentration of chlorophyll of all plants, and it has a considerable photosynthesis capacity. Since its discovery, chlorella has not ceased to generate considerable interest throughout the world, and today it is produced on a large scale for uses in food and nutritional supplements. Indeed, chlorella contains more than 60% of proteins which contain many amino acids essential to human and animal well-being. Chlorella also contains many vitamins (A, beta-carotene, B1: thiamine, B2: riboflavin, B3: niacin, B5: pantothenic acid, B6: pyridoxine, B9: folic acid, B12: cobalamin, vitamin C: ascorbic acid, vitamin E: tocopherol, vitamin K: phylloquinone), lutein (carotenoid family, powerful antioxidant) and minerals, including calcium, iron, phosphorus, manganese, potassium, copper and zinc. In addition, chlorella contains certain omega-type polyunsaturated fatty acids essential to good cardiac and brain function and to the prevention of numerous diseases such as cancer, diabetes or obesity.

The microalgal flour also provides other benefits, such as micronutrients, dietary fibers (soluble and insoluble carbohydrates), phospholipids, glycoproteins, phytosterols, tocopherols, tocotrienols and selenium.

There are a large number of benefits related to the consumption of chlorella. It is a food supplement used daily in Japan by 4 million people. It is used to such an extent that the Japanese government has classified it as a “food of national interest”.

Optionally, the microalgae used may be chosen, non-exhaustively, from Chlorella protothecoides, Chlorella kessleri, Chlorella minutissima, Chlorella sp., Chlorella sorokiniama, Chlorella luteoviridis, Chlorella vulgaris, Chlorella reisiglii, Chlorella ellipsoidea, Chlorella saccarophila, Parachlorella kessleri, Parachlorella beijerinkii, Prototheca stagnora and Prototheca moriformis. Preferably, the microalgae used according to the invention belong to the Chlorella protothecoides species.

In the context of the invention, Chlorella protothecoides is also chosen because of its high protein composition.

According to another advantageous embodiment of the invention, said product is characterized in that it also contains a polyol. This embodiment will be particularly suitable for products which must have a rather sweet flavor.

In the present invention, the term “polyols” denotes the products obtained by catalytic hydrogenation of monosaccharide or disaccharide reducing sugars. In particular, the polyol may be chosen from the group comprising sorbitol, xylitol, erythritol, maltitol, isomalt, isomaltitol, lactitol, alpha-D-glucopyranosyl-1,6-sorbitol (=1,6-GPS), alpha-D-glucopyranosyl-1,1-mannitol (=1,1-GPM), alpha-D-glucopyranosyl-1,1-sorbitol (=1,1-GPS) and any mixtures thereof, and preferably from maltitol, xylitol, sorbitol type 20/60, isomalt type M or erythritol.

Polyols are unquestionably tooth friendly: they are non-fermentable by the oral flora, non-acidogenic and non-cariogenic, and they create none of the conditions favourable to the appearance of tooth decay. On the contrary, by limiting the action of bacteria that are harmful to the teeth and by limiting the growth of dental plaque, polyols prevent dental enamel demineralization. These are all properties which allow them to proudly sport the logo of the dental Association Toothfriendly International. The polyol-based products can therefore also meet the criteria required to display this logo if they are free of cariogenic or erosive potential sometimes provided by other ingredients. This is a further, not insignificant, advantage for the snacks of the present invention.

According to one advantageous embodiment of the present invention, said product comprises a mixture of a composition of vegetable proteins, preferably leguminous-plant proteins, and even more preferentially pea proteins, and of at least one polyol.

According to this embodiment, the product obtained by compression comprises at least 75% of a composition of vegetable proteins and from 1% to 15% of at least one polyol. Preferably, the polyol is sorbitol.

The food product which is the subject of the invention obtained by compressing a pulverulent composition of essentially vegetable proteins, preferably of exclusively vegetable proteins, is in solid form, more particularly in the form of blocks, flat or rounded tablets, sticks or oblong tablets.

In a secondary embodiment of the invention, the products obtained by compression according to the invention can be consumed as they are, as snacks, but can also be used as they are or in milled form in the preparation of other products, such as chocolate, cereal bars, cereals, muesli, etc. This use makes it possible to add inclusions or clusters to other food products while still removing the allergenic risk of peanut inclusions normally used.

The compression process used to obtain the product which is the subject of the invention is a process well known to those skilled in the art.

The shaping of powders by compression is in fact a process widely used in many industrial sectors, such as powder metallurgy (metallic and ceramic powders), the food-processing industry, the cosmetics industry, the pharmaceutical industry and recently in the reduction of dust and packaging. However, given the properties of powders (or a mixture of powders) which are very sensitive to being worked, to origin or to handling, the success of the compaction process and the formation of a tablet which is in conformity requires an understanding of the fundamental properties of powders. These properties, which may be of physicochemical and/or mechanical type, make it possible to explain how a formulation might behave in compaction.

The main steps of the process for shaping by compression, preferably by direct compression, and more preferentially by simple compression in a matrix, can be described as the succession of four essential phases: filling the matrix, compressing or loading, unloading or withdrawing the punch, then ejecting.

The present invention also relates to a process for preparing said products, characterized in that it comprises the following steps:
of preparing a pulverulent composition comprising a vegetable protein or a vegetable protein mixture, preferably as a mixture with at least one flavoring, and preferably with at least one lubricant;
of filling the matrix of a press with said mixture;
of the action of directly compressing the mixture using a punch (loading);
of withdrawing the punch which produces the compression (unloading);
of ejecting the tablet;
and optionally of subjecting said tablet to a hard sweet-coating or film-coating process.

The filling of the matrix is generally carried out automatically in tablet presses. The pulverulent powder or composition of vegetable proteins as a mixture with at least one flavoring flows into the matrix and a shoe levels off the powder. The flow of the powder is provided by the joint effect of gravity and of the vibration of the shoe. However, it is necessary to avoid cohesive powders which flow poorly (a granulation operation is often used in this case) and to take care that, in the event of mixing powders, there is no segregation.

The compression is the step which makes it possible to make the powder or mixture more dense and to shape it into a tablet. The upper punch drives into the matrix. This driving in is controlled by a load or an applied movement. At the beginning of compaction, the particles rearrange by means of sliding and rotations so as to form a denser stack. The excess air is then removed from the powder bed and the number of points of contact between particles increases. At the end of this tamping down step, the particles can no longer slide with respect to one another and an actual resistance of the powder to the driving in of the punch is observed.

The pulverulent composition of vegetable proteins or vegetable protein mixture of use for obtaining the product which is the subject of the invention can be mixed, before being compressed, with at least one flavoring and preferably with at least one lubricant.

Other ingredients can also be added to the pulverulent composition of vegetable proteins. By way of example, mention may be made of flow agents such as silica, salt, etc.

The novel products according to the invention have, after compression, a texture very close to that of dried fruits, and more particularly of peanuts.

Indeed, when the novel products are consumed, they are crunchy and disintegrate in the form of small pieces reminiscent of those obtained during the consumption of said dried fruits.

This is explained by the very specific functional properties of the composition of vegetable proteins, preferably leguminous-plant proteins, and more preferentially pea proteins, used, which properties make it possible to obtain this sensory effect during the consumption of said products.

In the present application, the term “functional properties” of the food ingredients means any non-nutritional property which influences the usefulness of an ingredient in food. These various properties contribute to obtaining the desired final characteristics of the food. Some of these functional properties are the solubility, the hydration, the viscosity, the coagulation, the stabilization, the texturing, the paste formation, the foaming properties and the emulsifying and gelling capacities. The proteins also play an important role in the sensory properties of the food matrices in which they are used, and there is a real synergy between the functional properties and the sensory properties.

The functional properties of proteins, or functionality, are therefore the physical or physicochemical properties which have an effect on the sensory qualities of the food systems generated during technological transformations, storage or domestic culinary preparations.

It is noted that, whatever the origin of the protein, the latter has an influence on the color, the flavor and/or the texture of a product. These organoleptic characteristics have a determining influence on the choice made by the consumer and they are, in this case, greatly taken into account by manufacturers.

The functionality of proteins is the result of molecular interactions of the latter with their environment (other molecules, pH, temperature, etc.). These properties are generally classified into 3 groups:
hydration properties which group together the interactions of the protein with water: this covers the absorption, retention, wettability, swelling, adhesion, dispersion, viscosity, etc., properties,
structuring properties which group together the properties of protein-protein interaction: this covers the precipitation, coagulation, gelling, etc., phenomena,
surface properties which group together the properties of interaction of the proteins with other polar or nonpolar structures in the liquid or gas phase: this covers the emulsifying, foaming, etc., properties.

These various properties are not independent of one another since a functional property can result from several types of interactions or from several functional properties.

Thus, by virtue of the quite specific functional properties of the composition of vegetable proteins, preferably leguminous-plant proteins and more preferentially pea proteins, used in the present invention, it is possible to rediscover the structure of a dried fruit during the consumption of the products produced from these compositions of vegetable proteins, in particular leguminous-plant proteins or more preferentially pea proteins.

As previously specified, in another particular embodiment of the invention, said products may also have undergone a film-coating step, for example with the modified pea starch sold by the applicant under the brand name LYCOAT® and pigments such as those sold by the company MERCK under the brand name CANDURIN®.

In another embodiment of the invention, said products may also have undergone a hard sweet-coating step. Hard sweet-coating aims to obtain a hard sweet-coated layer which is preferably crunchy and more or less sweet. Hard sweet-coating always requires the use of a sweet-coating syrup containing, inter alia, crystallizable materials. The hard and crystalline coating is obtained by application of this syrup and evaporation of the water provided by said syrup. The term “hard sweet-coating” used in the present invention will also comprise very similar techniques, namely glazing and frosting.

Glazing consists of one or two applications or charges of a crystallizable syrup that is dilute relative to that used in hard sweet-coating. The aim is often to finish the surface appearance of sweet-coated products. Hard sweet-coating is often followed by glazing.

Frosting also aims to improve the appearance of products, but also to isolate the latter from atmospheric moisture. This technique resembles hard sweet-coating in that a crystalline syrup is used. The essential difference lies in the fact that the number of sweet-coating cycles performed is only one, two or three.

Hard sweet-coating processes are fully known to those skilled in the art and are, for example, described in applications EP 1 481 597 and EP 2 108 264 of which the applicant is the proprietor.

The invention will be understood even more clearly on reading the examples which follow, which are intended to be illustrative while referring only to certain embodiments and certain advantageous properties according to the invention, and nonlimiting.

### Example 1

### Recipe for Novel Snacks According to the Invention

### Recipe Used

| | % (by weight) |
|---|---|
| Composition of pea proteins according to the invention | 79.09 |
| NUTRALYS ® F85M | |
| Composition of wheat proteins NUTRALYS ® W | 4.11 |
| Dextrose GD, granulated | 10 |
| Peanut flavoring MANE E - RQT8800/67SA | 5 |
| Magnesium stearate | 1 |
| Silica | 0.2 |
| Salt (NaCl) | 0.6 |
| TOTAL | 100 |

The composition of pea proteins NUTRALYS® F85M sold by ROQUETTE FRÈRES contains 85% (percentage expressed relative to solids) of pea proteins.

The composition of wheat proteins that is used is sold by ROQUETTE FRÈRES under the trade name NUTRALYS® W.

The dextrose used is sold by ROQUETTE under the name Dextrose monohydrate GD.

The peanut flavoring is sold by the company V. MANE FILS located at Le Bar sur Loup (06620).

### Preparation Process

Mix all the ingredients together for 5 minutes, except for the magnesium stearate.
Add the magnesium stearate and remix everything for 5 minutes.
Use an alternating tablet press with oblong-shaped punches to obtain the products according to the invention.

### Example 2

### Recipe for Novel Snacks According to the Invention

### Recipe Used

| | % (by weight) |
|---|---|
| Composition of pea proteins according to the invention | 84.09 |
| NUTRALYS ® F85M | |
| Composition of wheat proteins NUTRALYS ® W | 4.11 |
| Dextrose GD, granulated | 5 |
| Peanut flavoring MANE E - RQT8800/67SA | 5 |
| Magnesium stearate | 1 |
| Silica | 0.2 |
| Salt (NaCl) | 0.6 |
| TOTAL | 100 |

The composition of pea proteins NUTRALYS® F85M sold by ROQUETTE FRÈRES contains 85% (percentage expressed relative to solids) of pea proteins.

The composition of wheat proteins that is used is sold by ROQUETTE FRÈRES under the trade name NUTRALYS® W.

The dextrose used is sold by ROQUETTE under the name Dextrose monohydrate GD.

The peanut flavoring is sold by the company V. MANE FILS located at Le Bar sur Loup (06620).

### Preparation Process

Mix all the ingredients together for 5 minutes, except for the magnesium stearate.
Add the magnesium stearate and remix everything for 5 minutes.
Use an alternating tablet press with oblong-shaped punches to obtain the products according to the invention.

### Example 3

### Tasting of the Products Obtained According to Examples 1 and 2

The products obtained according to examples 1 and 2 above were tasted by a jury composed of 20 individuals. The overall final grade was very good, both in terms of taste and in terms of texture. Their texture was judged to be similar to that of a peanut, i.e. crunchy and breaking up into small pieces when chewed.

Thus, the advantage of the invention is perfectly demonstrated. It is entirely possible to reproduce the taste and texture of peanuts while dispensing with the very bothersome allergenic aspect and decreasing the calorie content.

### Example 4

### Analysis of the Aminogram of the Products Obtained According to Example 2

The amino acid composition of the snacks obtained according to example 2 was determined according to the measuring methods well known to those skilled in the art. The amino acids are released from the proteins by acid hydrolysis (HCl 6 mol/l-24 h); and then they can be assayed by various chromatographic methods (TLC, HPLC, “autoanalyzer” with ion exchange column).

The table below presents the amino acids termed essential, i.e. indispensable and which cannot be synthesized de novo by the organism (generally human) or which are synthesized at an insufficient rate, and must therefore be provided by the diet, a condition necessary for the correct functioning of the organism.

In humans, there are eight essential amino acids: tryptophan, lysine, methionine, phenylalanine, threonine, valine, leucine and isoleucine. Two others, histidine and arginine, are termed semi-essential since only infants require an exogenous provision (they are found in maternal milk).

in g/100 g protein (N × 6.25)

| | | | | Protein |
|---|---|---|---|---|
| | FAO adult | Nutralys | Nutralys | snack |
| | 2008 | F85M | W | ratio 95/5 |
| Cysteine + Methionine | 2.2 | 2.1 | 3.5 | 2.17 |
| Histidine | 1.5 | 2.5 | 2 | 2.48 |
| Isoleucine | 3 | 4.7 | 3.4 | 4.64 |
| Leucine | 5.9 | 8.2 | 6.7 | 8.13 |
| Lysine | 4.5 | 7.1 | 1.4 | 6.82 |
| Phenylalanine + Tyrosine | 3.8 | 9.3 | 8.7 | 9.27 |
| Threonine | 2.3 | 3.8 | 2.6 | 3.74 |
| Tryptophan | 0.6 | 1 | 1 | 1.00 |
| Valine | 3.9 | 5 | 3.8 | 4.94 |
| AAS | | 95 | 31 | 99 |

### Amount in g in the Formula of the Snacks:

| | |
|---|---|
| Nutralys F85M | 84.09 |
| Nutralys W | 4.11 |
| | g/100 g product |

Spreadsheet with Calculation Formula Taking into Account the Protein Share in these Ingredients

| | g | g/l |
|---|---|---|
| Nutralys F85M | 67.27 | 95.1 |
| Nutralys W | 3.49 | 4.9 |
| TOTAL | 70.77 | 100 |
| | g/100 g product | g/100 g protein |

The amino acid profile of the snacks is compared with the recommendations of the Food and Agriculture Organization of the United Nations (FAO).

It is seen that the pea protein/wheat protein ratio makes it possible to have an aminogram regarding the essential amino acids that is very close to that recommended by the FAO.

The advantage of the invention from the nutritional point of view is therefore also confirmed.

Consuming the snacks according to the invention makes it possible to provide the body with the correct amounts of amino acids termed essential.

### Example 5

### Other Recipes for Novel Snacks According to the Invention

Examples A and B concern snacks according to the invention containing a mixture of pea proteins and wheat proteins.

Example C concerns snacks according to the invention containing pea proteins and soluble fibers.

Example D concerns snacks according to the invention containing pea proteins as sole protein source.

Example E concerns snacks according to the invention containing pea proteins and algal proteins.

Example F concerns snacks according to the invention containing pea proteins and sorbitol.

All the products obtained according to tests A to F above were tasted by a jury composed of 20 individuals. The overall final grade was very good, both in terms of taste and in terms of texture. Their texture was judged to be similar to that of a peanut for tests A and B, i.e. crunchy and breaking up into small pieces when chewed.

For tests C to F, the texture and the taste of the various snacks were also judged to be very pleasant and satisfying.

| % by weight | A | B | C | D | E | F |
|---|---|---|---|---|---|---|
| Composition of pea | 84 | 79.09 | 46.7 | 24.8 | 20.7 | 89.7 |
| proteins according to | | | | | | |
| the invention | | | | | | |
| NUTRALYS ® F85M | | | | | | |
| Composition of wheat | 4.2 | 4.11 | — | — | — | — |
| proteins NUTRALYS ® W | | | | | | |
| NUTRIOSE ® | — | — | 50 | — | — | — |
| soluble fibers | | | | | | |
| Dextrose GD, granulated | 5 | 10 | — | 72 | 44 | — |
| Protein-rich algal flour | — | — | — | — | 30 | — |
| Sorbitol powder | — | — | — | — | — | 5 |
| NEOSORB ® | | | | | | |
| P300 DC | | | | | | |
| Peanut flavoring MANE | 5 | 5 | — | — | — | — |
| E - RQT8800/67SA | | | | | | |
| Bacon flavoring | — | — | — | — | 3 | 3 |
| Caramel flavoring | — | — | 2 | 2 | — | — |
| Magnesium stearate | 1 | 1 | 1 | 1 | 1 | 1 |
| Silica | 0.2 | 0.2 | 0.2 | 0.1 | 0.5 | 0.5 |
| Salt (NaCl) | 0.6 | 0.6 | 0.1 | 0.1 | 0.8 | 0.8 |
| TOTAL | 100 | 100 | 100 | 100 | 100 | 100 |

1-19. (canceled)

20. A food product obtained by compressing a pulverulent composition comprising an essentially, preferably exclusively, vegetable protein or protein mixture.

21. The food product as claimed in claim 20, wherein the vegetable protein(s) belong(s) to proteins derived from cereals, from oleaginous plants, from leguminous plants and from tubers, and also all the proteins derived from algae and from microalgae.

22. The food product as claimed in claim 20, wherein the vegetable protein belongs to leguminous-plant proteins, the leguminous-plant protein preferably being chosen from the group consisting of alfalfa protein, clover protein, lupin protein, pea protein, bean protein, broad bean protein, horse bean protein, lentil protein, and mixtures thereof.

23. The food product as claimed in claim 22, wherein the vegetable protein is a pea protein.

24. The food product as claimed in claim 20, which contains at least 15% of a composition of vegetable proteins, these percentages being expressed relative to the total weight of the ingredients used in the recipe for preparing said product.

25. The food product as claimed in claim 20, containing at least 50%, of a composition of vegetable proteins, this percentage being expressed relative to the total weight of the ingredients used in the recipe for preparing said product.

26. The food product as claimed in claim 20, containing at least 60% of vegetable proteins, this percentage being expressed relative to the total weight of the ingredients used in the recipe for preparing said product.

27. The food product as claimed in claim 20, containing at least 70% of vegetable proteins, this percentage being expressed relative to the total weight of the ingredients used in the recipe for preparing said product.

28. The food product as claimed in claim 20, containing at least 75% of vegetable proteins, this percentage being expressed relative to the total weight of the ingredients used in the recipe for preparing said product.

29. The food product as claimed in claim 20, containing from 15% to 50% of a soluble vegetable fiber, this percentage being expressed relative to the total weight of the ingredients used in the recipe for preparing said product.

30. The food product as claimed in claim 29, wherein the soluble vegetable fiber is chosen from fructans including fructooligosaccharides (FOSs) and inulin, glucooligosaccharides (GOSs), isomaltooligosaccharides (IMOs), trans-galactooligosaccharides (TOSs), pyrodextrins, polydextrose, branched maltodextrins, indigestible dextrins and soluble oligosaccharides derived from oleaginous or protein-producing plants or mixtures thereof.

31. The food product as claimed in claim 29, wherein the soluble vegetable fiber is a branched maltodextrin.

32. The food product as claimed in claim 20, containing from 15% to 50% of a microalgal flour, this percentage being expressed relative to the total weight of the ingredients used in the recipe for preparing said product.

33. The food product as claimed in claim 32, wherein the microalgal flour is a flour of microalgae of the Chlorella genus.

34. The food product as claimed in claim 20, containing from 1% to 15% of at least one polyol, and preferably of sorbitol.

35. The food product as claimed in claim 20, containing between 1% and 10% of flavorings, and preferably between 2% and 6%, these percentages being expressed relative to the total weight of the ingredients used in the recipe for preparing said product.

36. The food product as claimed in claim 20, having undergone a final treatment chosen from hard sweet-coating and film-coating.

37. A process for preparing the food product as claimed in claim 20, comprising the following steps:
preparing a pulverulent composition comprising a vegetable protein or a vegetable protein mixture, preferably as a mixture with at least one flavoring;
filling the matrix of a press with said mixture;
directly compressing the mixture into a tablet using a punch;
withdrawing the punch which produces the compression;
ejecting the tablet;
optionally subjecting said tablet to a hard sweet-coating or film-coating process.

38. A substitute for allergenic dried fruit comprising the product as claimed in claim 20.

39. The food product as claimed in claim 20, which contains at least 20%, of a composition of vegetable proteins, these percentages being expressed relative to the total weight of the ingredients used in the recipe for preparing said product.

40. The food product as claimed in claim 32, wherein the microalgal flour is a flour of microalgae of the Chlorella protothecoides species.

41. The food product as claimed in claim 20, containing between 2% and 6% of flavorings, these percentages being expressed relative to the total weight of the ingredients used in the recipe for preparing said product.
